(19) United States
(12) Patent Application Publication
(10) Pub. No.: US 2014/0166408 A1
(43) Pub. Date: Jun. 19, 2014

(54) Drive and Elevator Electronics in Bedplate

(71) Applicants: Kyle W. Rogers, Farmington, CT (US); HanJong Kim, Avon, CT (US)

(72) Inventors: Kyle W. Rogers, Farmington, CT (US); HanJong Kim, Avon, CT (US)

(73) Assignee: Otis Elevator Company, Farmington, CT (US)

(21) Appl. No.: 14/236,127

(22) PCT Filed: Aug. 8, 2011
(86) PCT No.: PCT/US11/46936

§ 371 Date: Jan. 30, 2014

(51) Int. Cl. B66B 11/00

(52) U.S. Cl. CPC B66B 11/0045
USPC 187/276

(57) ABSTRACT

A bedplate assembly is provided. The bedplate assembly may include a support member having a mounting surface for receiving a machine, a compartment internally disposed within the support member, and electronics disposed within the compartment.

### FIELD OF THE DISCLOSURE

The present disclosure generally relates to electronics packaging, and more particularly, to packaging for elevator drive components and other related electronics.

### BACKGROUND OF THE DISCLOSURE

Vertical travel of an elevator car is typically powered by a drive assembly that may be supported within an upper portion of an elevator hoistway by a support member, such as a bedplate. The drive assembly generally includes a traction machine composed of a gearless motor and a traction sheave, both of which may be mounted on a surface of the bedplate. Rotational torque generated by the gearless motor is used to rotate the traction sheave. Depending on the direction of rotation of the motor, the traction sheave causes the tension members to lift or lower the elevator cab vertically through the hoistway and relative to the bedplate. Power and control of the machine or the associated motor are provided by the motor drive components.

Some existing elevator systems position the motor drive components within a housing or cabinet that is mounted within the hoistway, such as mounted to the hoistway wall. Typical cabinets and associated drives can be relatively far from the motor which it operates. Accordingly, motor wiring connecting the drive electronics to the machine or motor must sufficiently extend from the location of the cabinet to the bedplate. This requires the installation of substantially lengthy motor wiring, which further results in greater installation times and added expenses.

In other elevator systems, the drive is provided on an exterior surface of the bedplate. Such configurations position the drive closer to the machine and thus reduce the length of motor wiring. However, this configuration still requires the drive electronics to reside within a protective housing that protects against environmental conditions such as dust and debris. In addition, the protective housing, because of the close proximity between the drive electronics and the motor, is metallic to provide electromagnetic interference (EMI) shielding between the drive electronics and the motor or traction machine. These additional components and considerations still add to the overall cost of implementation.

### SUMMARY OF THE DISCLOSURE

In accordance with one aspect of the disclosure, a bedplate assembly is provided. The bedplate assembly may include a support member having a mounting surface for receiving a machine, a compartment internally disposed within the support member, and electronics disposed within the compartment.

In a refinement, the mounting surface may be configured to receive an elevator motor and a traction sheave.

In another refinement, the compartment may be configured to receive a coverless drive component and the support member may be configured to substantially shield transmission of electromagnetic interference (EMI) between the machine and the drive component.

In another refinement, the support member may include at least one access point enabling user access to the compartment.

In a related refinement, the access point may be disposed on a surface of the support member opposing the mounting surface.

In another related refinement, the access point may include a panel removably coupled to the support member with one or more of bolts, hinges, and latches.

In another refinement, the support member may include vent openings configured to dissipate heat from the compartment.

In another refinement, the support member may include one or more passageways for wiring extending between the compartment and the mounting surface.

In yet another refinement, the bedplate assembly may be provided in combination with the machine mounted to the support member.

In a related refinement, the bedplate assembly may be provided in combination with wiring between the machine and the electronics, wherein the wiring is routed through one or more passageways disposed in the support member.

In accordance with another aspect of the disclosure, a kit for subsequent installation in an elevator system is provided. The kit may include a bedplate having a support member with a mounting surface for receiving a machine and a compartment, and electronics disposed within the compartment.

In a refinement, the electronics may be coverless, and the bedplate and the compartment may be configured to substantially shield transmission of EMI between the machine and the electronics.

In another refinement, the bedplate may include at least one access point enabling user access to the electronics.

In a related refinement, the access point may be disposed on a surface of the bedplate opposing the mounting surface.

In another related refinement, the access point may include a panel removably coupled to the bedplate with one or more of bolts, hinges, and latches.

In another refinement, the bedplate may include vent holes configured to dissipate heat generated by the electronics.

In another refinement, the bedplate may include one or more passageways for wires extending between the compartment and the mounting surface.

In yet another refinement, the kit may be provided in combination with the machine mounted to the support member.

In a related refinement, the kit may be provided in combination with wiring between the machine and the electronics, wherein the wiring is routed through one or more passageways disposed in the support member.

These and other aspects of this disclosure will become more readily apparent upon reading the following detailed description when taken in conjunction with the accompanying drawings.

### BRIEF DESCRIPTION OF THE DRAWINGS

FIG. 1 is a partial perspective view of an elevator system constructed in accordance with the teachings of the disclosure;

FIG. 2 is a partial perspective view of one exemplary elevator drive assembly constructed in accordance with the teachings of the disclosure;

FIG. 3 is a cross-sectional view of one exemplary bedplate assembly constructed in accordance with the teachings of the disclosure;

FIG. 4 is a cross-sectional view of one exemplary electronics compartment of the bedplate assembly of FIG. 3; and

FIG. 5 is a cross-sectional view of another exemplary electronics compartment of the bedplate assembly of FIG. 3.

While the present disclosure is susceptible to various modifications and alternative constructions, certain illustrative embodiments thereof have been shown in the drawings and will be described below in detail. It should be understood, however, that there is no intention to be limited to the specific forms disclosed, but on the contrary, the intention is to cover all modifications, alternative constructions, and equivalents falling with the spirit and scope of the present disclosure.

### DETAILED DESCRIPTION

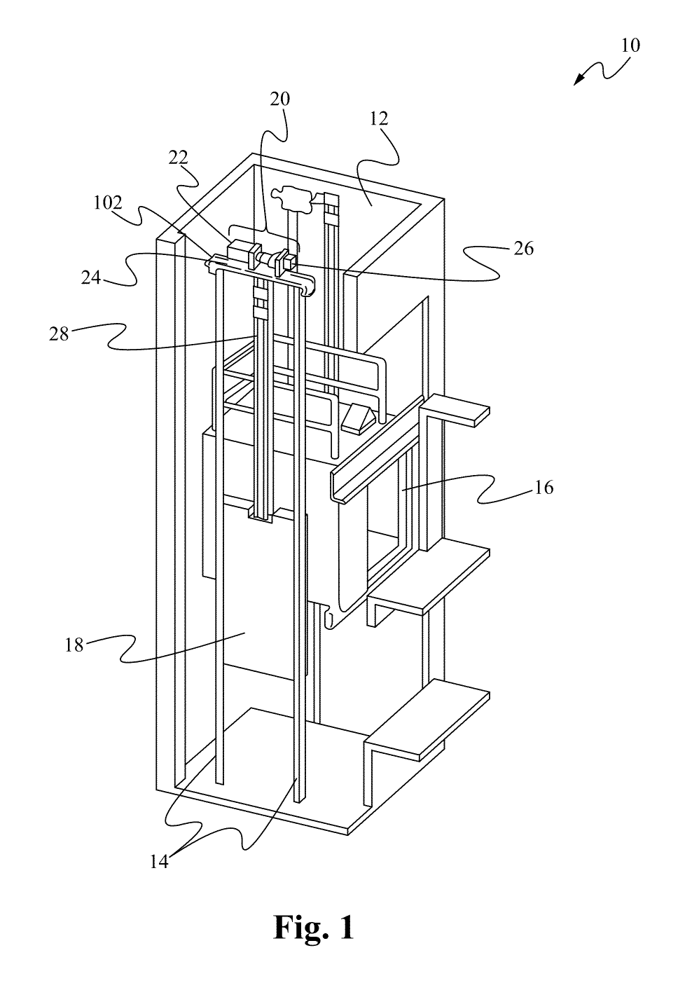

Referring now to FIG. 1, a schematic diagram of an exemplary elevator system 10 is provided. It is to be understood that the version of the elevator system 10 shown in FIG. 1 is for illustrative purposes only and to present background for some of the various components of a general elevator system. Other components of an elevator system unnecessary for an understanding of the present disclosure are not described.

As shown in FIG. 1, the elevator system 10 may reside fully or partially in a hoistway 12 that is vertically disposed within a building. The hoistway 12 may generally include a hollow shaft provided within a central portion of the building with multiple hoistways being provided if the building is of sufficient size and includes multiple elevators. Additionally, rails 14 may extend substantially the length of the hoistway 12, along which an elevator cab 16 as well as counterweights 18 may be slidably mounted. While not depicted in detail, one of ordinary skill in the art will understand that both the elevator cab 16 and the counterweight 18 may further include rollers, slide guides, or the like, that slidably engage the rails 14 in a secure fashion so as to provide for a smooth motion of the cab 16 and/or counterweight 18 along the rails 14.

The elevator cab 16 may be caused to vertically move within the hoistway 12 by a machine 20 of the elevator system 10. For example, the machine 20 may be a gearless traction machine having an electric motor 22 that is driven by a drive component 24. Moreover, the motor 22 may generate a rotational torque that is communicated toward an associated traction sheave 26. Upon rotation of the traction sheave 26, one or more tension members 28 engaging the traction sheave 26 may serve to pull up or let down the elevator cab 16 through the hoistway 12 to the desired height. The drive component 24 may provide power and the appropriate control signals to the motor 22. Specifically, the power and control signals provided by the drive component 24 may correspond to the desired control of the elevator cab 16 as indicated by passengers of the elevator system 10.

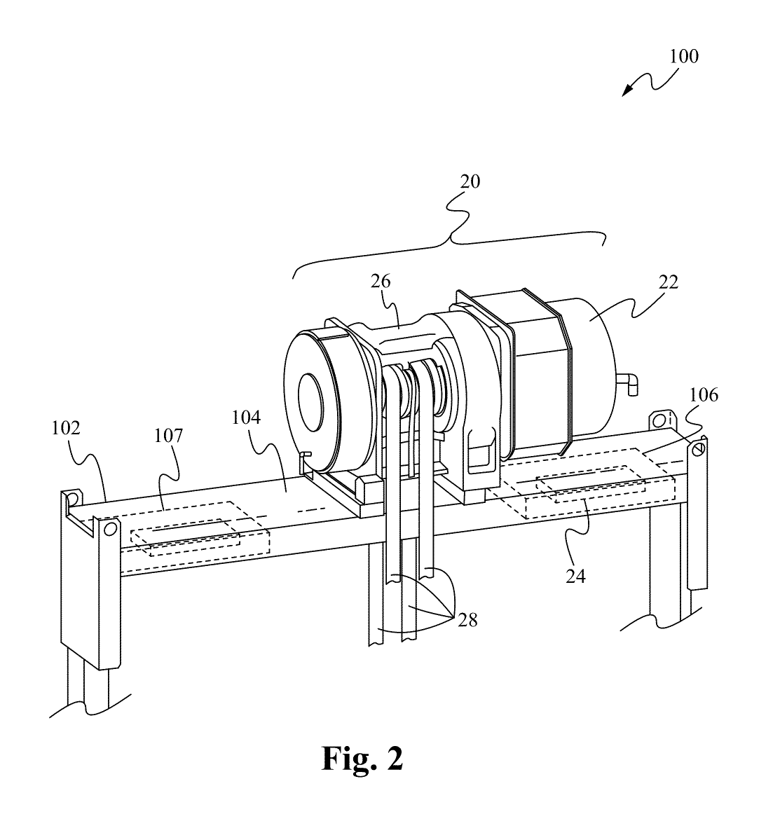

Turning to FIG. 2, one exemplary elevator drive assembly 100 that may be associated with the machine 20 is provided. For example, the elevator drive assembly 100 may generally include the machine 20 of the elevator system 10 and a bedplate 102 for supporting the machine 20 within an upper segment of the hoistway 12. More specifically, the bedplate 102 may include a mounting surface 104 upon which at least the motor 22 and the traction sheave 26 may be mounted. As an example, the bedplate 102 could be mounted to one or more of the rails 14 within the hoistway 12. The bedplate 102 may be shaped to provide a compartment 106 that is configured to receive the drive component 24 therein. In alternate embodiments, the bedplate 102 may be shaped to provide a compartment 107 configured to receive any additional electronic components therein. The compartments 106, 107 could be separate compartments or part of a single compartment. The bedplate 102 and the compartment(s) 106, 107 may be configured to substantially shield the machine 20 or motor 22 from any electromagnetic interference (EMI) that may be caused by the drive component 24 and other related electronic components, as well as to substantially shield the contents of the compartment(s) 106, 107 from any EMI that may be caused by the machine 20 or motor 22. For example, the bedplate 102 and/or the interior lining of the compartment(s) 106, 107 may be formed of a sheet metal or any other material suitable for providing a substantial EMI shield between the machine 20 and the drive component 24 and/or any electronic components associated therewith. The drive component 24 and/or other electronic components could be positioned in any suitable manner within the compartments 106, 107. The drive component 24 and any related electronic components may be provided without individual covers. Furthermore, the elevator drive assembly 100, including the bedplate 102, the compartment(s) 106, 107, the machine 20 and the associated drive component 24 and/or other electronic components, may be readily scaled to meet the sizing and power requirements of different applications.

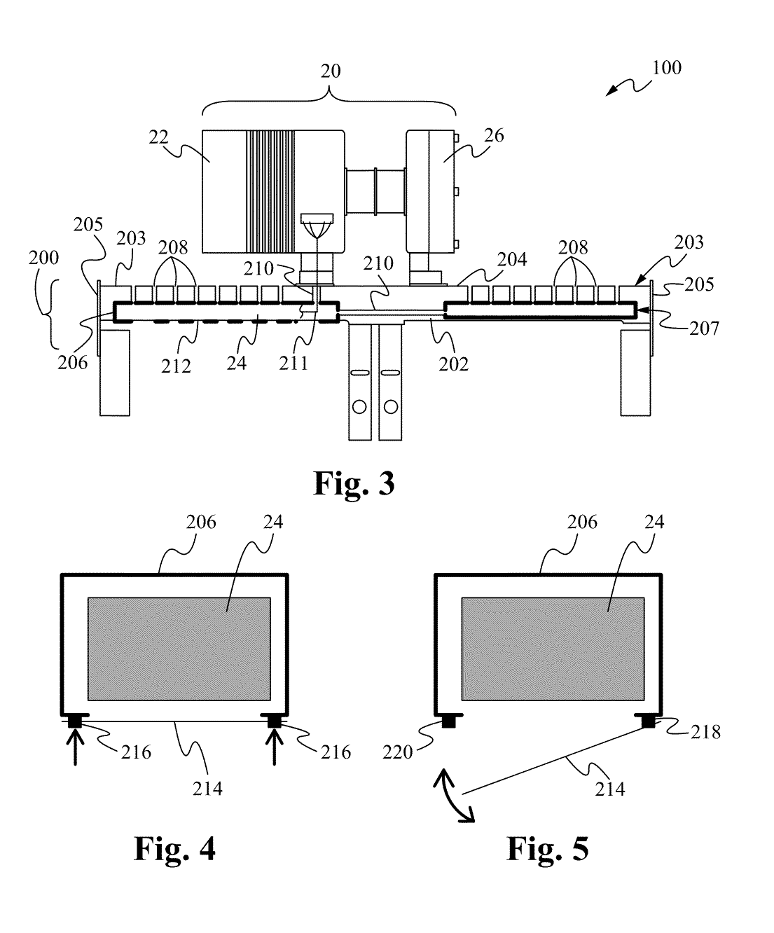

Referring now to FIG. 3, one exemplary bedplate arrangement 200 that may further be provided as a part of the elevator drive assembly 100 is provided. Although other shapes are possible, the bedplate arrangement 200 of FIG. 3 may generally be comprised of a U-shaped support member 202 having a web portion 203 with a mounting surface 204 and two flange portions 205 extending from the web portion 203. The web 203 and flanges 205 define one or more compartments 206, 207. The compartments 206, 207 could be separate compartments or part of a single compartment. The mounting surface 204 may be configured to support and receive a machine 20 thereon, while the compartment(s) 206, 207 may house a drive component 24 and/or other electronic components associated therewith. As in the bedplate 102 of FIG. 2, the support member 202 and/or the compartment(s) 206, 207 may be configured to substantially shield the machine 20 or motor 22 from any EMI that may be caused by the drive component 24, as well as to substantially shield the drive component 24 and/or any associated electronics placed therein from any EMI that may be caused by the machine 20 or motor 22. For example, the support member 202 and/or the interior lining of the compartment(s) 206, 207 may be formed of a sheet metal or any other material suitable for providing a substantial EMI shield between the machine 20 or motor 22 and the drive component 24 and/or associated electronics. Furthermore, the drive component 24 and/or any associated electronics may also be positioned within the compartment(s) 206, 207 closer to the distal ends of the flanges 205 of the support member 202, and farther away from the mounting surface 204 on the web 203 and the machine 20 so as to reduce any adverse effects that may be caused by EMI. Due to the inherent shielding properties of the support member 202 and the compartment(s) 206, 207, the bedplate assembly 200 may be used with drive components 24 and/or other related electronics that may not be individually covered or configured for EMI shielding.

Still referring to the bedplate assembly 200 of FIG. 3, the support member 202 may include one or more vent openings 208 that communicate with the compartment(s) 206, 207 and are configured to passively dissipate any heat that may be generated from within the compartment(s) 206, 207 by the drive component 24 and/or other electronics. As shown, the vent opening 208 are disposed on the web 203 of the support member 202, but alternatively or additionally may be disposed on the flanges 205 of the support member 202 and communicate with the compartment(s) 206, 207. Furthermore, the vent openings 208 may be configured so as to reduce the transmission of any EMI to pass therethrough. For example, each vent opening 208 may be sized to be smaller than the shortest foreseeable wavelength of EMI that may be caused by the drive component 24 and/or other electronic components, or any EMI that may be caused by the machine 20. Moreover, the vent openings 208 could be provided with a mesh screen or honeycomb cell (neither shown) to attenuate the EMI.

The support member 202 may also include one or more passageways 210 in communication with the compartment(s) 206 207 configured to route any wiring 211 that may be connected between, for example, the machine 20 and the drive component 24. More specifically, the one or more passageways 210 may extend from the compartment(s) 206, 207 through the web 203 to the mounting surface 204, upon which the machine 20 is disposed. As with the compartment(s) 206, 207, the passageways 210 may be configured to allow wiring to extend therethrough but limit or prevent EMI from affecting the machine 20 or motor 22 as well as the drive components 24 and/or other electronics.

The U-shaped support member 202 of FIG. 3 may provide adequate EMI shielding between the machine 20 or motor 22 and the drive components 24 and/or other electronics in the compartment(s) 206, 207. In this arrangement, the U-shaped support member 202 has an opening or an access point 212 to the compartment(s) 206, 207 from the underside of the bedplate assembly 200. The opening 212 is configured to enable user access, for example, access by maintenance personnel, or the like, to the electronic contents disposed in the compartment(s) 206, 207. More specifically, the access point 212 may serve to facilitate any troubleshooting, maintenance, service, repair, replacement, or the like, that may be required of the drive component 24 and/or other electronics housed within the compartments 206, 207. Alternatively, the bedplate assembly 200 could include a panel 214 that, along with the web 203 and flanges 205, encloses the drive component 24 and/or other electronics in the compartment(s) 206, 207. With the web 203, flanges 205 and panel 214 enclosing the drive component 24 and/or other electronics in the compartment(s) 206, 207, this alternative bedplate assembly can provide additional EMI protection to the machine 20 or motor 22 as well as to the electronics. In this alternative, the panel 214 (or a portion of the panel) could be, for example, removable using screws, bolts or other suitable fasteners 216 such as shown in FIG. 4 or partially removable using hinges 218, latches 220, and/or the like as shown in FIG. 5. Alternatively, the access point 212 may be disposed on one or more of the other surfaces of the support member 202. For example, as shown in FIG. 3, the access point 212 may be through the flanges 205 or web 203 of the support member 202.

The location of the drive component 24 and/or other electronics within the compartment(s) 206, 207 may provide adequate protection to the drive component 24 and/or other electronics such that the drive component 24 and/or other electronics could be mounted to the support member 202 before being shipped to the jobsite for subsequent installation in the elevator system 10. In other words, the support member 202 and the drive component 24 and/or other electronics comprise a kit that can be shipped to the jobsite for subsequent installation in the elevator system 10. The kit could alternatively include other components, such as the wiring 211 and/or the machine 20.

### INDUSTRIAL APPLICABILITY

The electronics packaging and assemblies disclosed herein may be used in a wide range of industrial or commercial applications, such as with drive components and machines in elevator systems. Positioning the drive electronics within a support member or bedplate of a machine may move the drive electronics closer to the machine while providing a sufficient shield between the machine as well as the drive from EMI. By placing the drive electronics closer to the machine, the required length of wiring interconnecting the drive to the machine may be reduced. The inherent shielding provided by the body of the bedplate and its compartments may enable the drive electronics to be provided without a cover and reduce costs. By placing the drive electronics within the body of the bedplate, space and material costs are also reduced. Additionally, the bedplate may be preassembled or packaged with the drive component, and in some instances with the machine, prior to delivery to the field so as to reduce the overall time and expenses associated with installation. Furthermore, the elevator drive assembly including the bedplate, the compartments, the machine and the associated drives may be readily scaled to meet the sizing and power requirements of different applications.

While only certain embodiments have been set forth, alternatives and modifications will be apparent from the above description to those skilled in the art. These and other alternatives are considered equivalents and within the spirit and scope of this disclosure.

1. A bedplate assembly, comprising:
a support member having a mounting surface for receiving a machine;
a compartment internally disposed within the support member; and
electronics disposed within the compartment.

2. The bedplate assembly of claim 1, wherein the mounting surface is configured to receive an elevator motor and a traction sheave.

3. The bedplate assembly of claim 1, wherein the compartment is configured to receive a coverless drive component and the support member is configured to substantially shield transmission of electromagnetic interference between the machine and the drive component.

4. The bedplate assembly of claim 1, wherein the support member includes at least one access point enabling user access to the compartment.

5. The bedplate assembly of claim 4, wherein the access point is disposed on a surface of the support member opposing the mounting surface.

6. The bedplate assembly of claim 4, wherein the access point includes a panel removably coupled to the support member with one or more of bolts, hinges, and latches.

7. The bedplate assembly of claim 1, wherein the support member includes vent openings configured to dissipate heat from the compartment.

8. The bedplate assembly of claim 1, wherein the support member includes one or more passageways for wiring extending between the compartment and the mounting surface.

9. The bedplate assembly of claim 1, in combination with the machine mounted to the support member.

10. The bedplate assembly of claim 9, in combination with wiring between the machine and the electronics, wherein the wiring is routed through one or more passageways disposed in the support member.

11. A kit for subsequent installation in an elevator system, comprising:
a bedplate having a support member with a mounting surface for receiving a machine and a compartment; and
electronics disposed within the compartment.

12. The kit of claim 11, wherein the electronics is coverless, and the bedplate and the compartment are configured to substantially shield transmission of electromagnetic interference between the machine and the electronics.

13. The kit of claim 11, wherein the bedplate includes at least one access point enabling user access to the electronics.

14. The kit of claim 12, wherein the access point is disposed on a surface of the bedplate opposing the mounting surface.

15. The kit of claim 12, wherein the access point includes a panel removably coupled to the bedplate with one or more of bolts, hinges, and latches.

16. The kit of claim 11, wherein the bedplate includes vent holes configured to dissipate heat generated by the electronics.

17. The kit of claim 11, wherein the bedplate includes one or more passageways for wires extending between the compartment and the mounting surface.

18. The kit of claim 11, in combination with the machine mounted to the support member.

19. The kit of claim 18, in combination with wiring between the machine and the electronics, wherein the wiring is routed through one or more passageways disposed in the support member.
